(19) United States
(12) Patent Application Publication
(10) Pub. No.: US 2003/0084758 A1
(43) Pub. Date: May 8, 2003

(54) Rotary screwdriver with hidden and replaceable screwdriver bits

(76) Inventor: Mei Hui Chiang, Taichung (TW)

Correspondence Address: Mei Hui Chiang, P.O. BOX 2103, Taichung, TW

(21) Appl. No.: 10/107,735

(22) Filed: Mar. 28, 2002

(30) Foreign Application Priority Data
Nov. 2, 2001 (TW) 090218776

(51) Int. Cl. B25G 1/08

(52) U.S. Cl. 81/490

(57) ABSTRACT

A rotary screwdriver with hidden and replaceable screwdriver bits, including a grip and a push member. The push member has an engaging section. A roller is disposed in the grip in an eccentric position. The roller is formed with multiple receiving tunnels which are annularly arranged at intervals. A screwdriver bit is received in each receiving tunnel. Each screwdriver bit is formed with an insertion section corresponding to the engaging section for engaging with the push member. By means of rotating the roller, the push member can be engaged with a desired screwdriver bit of the multiple screwdriver bits. By means of pushing the push member, the screwdriver bit engaged with the push member is pushed out of the outlet and located for use or retracted into the receiving tunnel.

### BACKGROUND OF THE INVENTION

The present invention is related to a rotary screwdriver with hidden and replaceable screwdriver bits, and more particularly to a screwdriver of which the screwdriver bits are easily replaceable and prevented from missing.

FIGS. 10 and 11 show a conventional screwdriver. The grip 71 of the screwdriver is formed with multiple receptacles 72 which are annularly arranged. The receptacles 72 are open on front end face, whereby different screwdriver bits 76 can be inserted and received in the receptacles 72. A cover 73 is disposed at front end of the grip 71 and formed with a perforation 74 corresponding to the receptacles 72. The front end of the grip is further equipped with a coupling stem 75 passing through the cover 73. A screwdriver bit 76 can be inserted in the coupling stem 75.

In use, a user can rotate the cover 73 to aim the perforation 74 thereof at the receptacle 72 in which a screwdriver bit 76 to be used is received. Then the user can make the screwdriver bit drop out from the perforation 74 and insert the screwdriver bit into the coupling stem 75 for use. When stored, the cover is rotated to block the receptacles 72 and prevent the screwdriver bits 76 from dropping out.

The screwdriver bits are simply placed in the receptacles 72. In case a user incautiously fails to turn the cover 73 to the closing position, the screwdriver bits 76 are very easy to drop out from the receptacles 72. This leads to inconvenience in use or carriage of the screwdriver.

Moreover, in use, it is necessary to first take out the screwdriver bit and then insert the screwdriver bit into the coupling stem 75. When stored, the screwdriver bit is extracted and again placed into the receptacle 72. Such replacement procedures are frequently performed and quite troublesome. Also, the screwdriver bits tend to miss.

FIGS. 12 and 13 show another type of conventional screwdriver having a main seat body 81. A side seat 82 is coaxially rotatably disposed on one side of the main seat body 81. The side seat is formed with a perforation in which a push pin 83 is fitted. The push pin has a magnetic push section 831 at front end. The main seat body has an outward projecting tubular body 84 formed with a tunnel 841. A rotary bush 85 is fitted in the tunnel 841. The rotary bush is formed with a hexagonal hole 851. A rotary wheel 86 is disposed in the main seat body. The circumference of the rotary wheel is formed with multiple annularly arranged sockets 861 in which screwdriver bits 87 are received.

In use, the push pin 83 is pushed forward to push a screwdriver bit 87 to the rear end of the bush 85 for use. When pulling back the screwdriver bit for replacement the screwdriver bit with a different one, the push section 831 magnetically attracts the screwdriver bit to pull back the same.

However, the hexagonal screwdriver bit 87 contacts with the wall of the hexagonal hole of the bush 85 on many corners. Therefore, it is hard to simply magnetically attract and pull the screwdriver bit within the hexagonal hole of the bush 85.

In addition, the screwdriver bit is simply located by the magnetic attraction of the end of the push pin. Therefore, the screwdriver bit tends to drop out of the bush in carriage due to collision.

Furthermore, the bush 85 is rotatable within the tunnel 841. In the case that the bush is slightly deflected in the tunnel, it will be hard to successfully push the screwdriver bit into the bush.

Also, the rotary wheel 86 protrudes from one side of the main seat body 81. When the screwdriver bit is extended out of the bush for use, the screwdriver bit is positioned in an eccentric position from the main seat body 81. Accordingly, when using the screwdriver, a user needs to hold the main seat body with one hand and operate the push pin 83 with the other hand. Therefore, it is inconvenient for the user to operate the screwdriver.

### SUMMARY OF THE INVENTION

It is therefore a primary object of the present invention to provide a rotary screwdriver with hidden and replaceable screwdriver bits. The screwdriver bits of the screwdriver are easily replaceable and not easy to miss. The screwdriver has a roller and a push member. In use, a user only needs to rotate the roller to engage the push member with a desired screwdriver bit and push the push member to extend the desired screwdriver bit out of the outlet of the grip. The screwdriver bit is then located for use. When not used, the screwdriver bits can be received in the receiving tunnels of the roller without being taken out from the grip. Therefore, the screwdriver can be conveniently used and the screwdriver bits are prevented from missing.

The present invention can be best understood through the following description and accompanying drawings wherein:

### BRIEF DESCRIPTION OF THE DRAWINGS

FIG. 1 is a perspective exploded and partially sectional view of the present invention;

FIG. 2 shows that the push member is engaged with the screwdriver bit, in which the flange stops the rear sides of the screwdriver bits to make the insertion sections thereof positioned on the same cross-section;

FIG. 3A is a sectional view of the present invention, in which the screwdriver bits are retracted;

FIG. 3B is a sectional view of the present invention, in which the screwdriver bits are extended out of the outlet for use;

FIG. 4 is a sectional view taken along line IV-IV of FIG. 3A;

FIG. 5 shows that the push button is depressed, permitting the push member to move back and forth;

FIG. 6 shows that the flange stops the rear ends of the screwdriver bits;

FIG. 7 shows another aspect of insertion section of the screwdriver bit;

FIG. 8 is a perspective exploded view of a second embodiment of the present invention;

FIG. 9A is a sectional view of the second embodiment of the present invention, in which the screwdriver bits are retracted;

FIG. 9B is a sectional view of the second embodiment of the present invention, in which the screwdriver bits are extended out of the outlet for use;

FIG. 10 is a perspective assembled view of a conventional screwdriver;

FIG. 11 is a perspective exploded view of the conventional screwdriver of FIG. 10;

FIG. 12 is a perspective exploded view of another type of conventional screwdriver; and

FIG. 13 is a sectional view of the conventional screwdriver of FIG. 12.

### DETAILED DESCRIPTION OF THE PREFERRED EMBODIMENTS

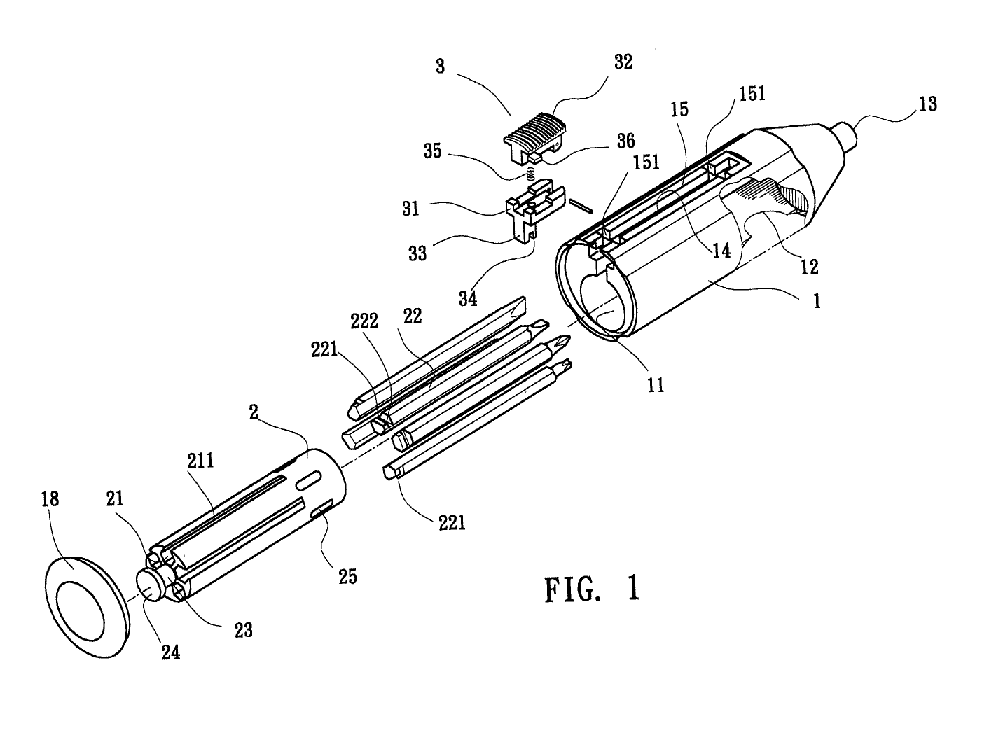

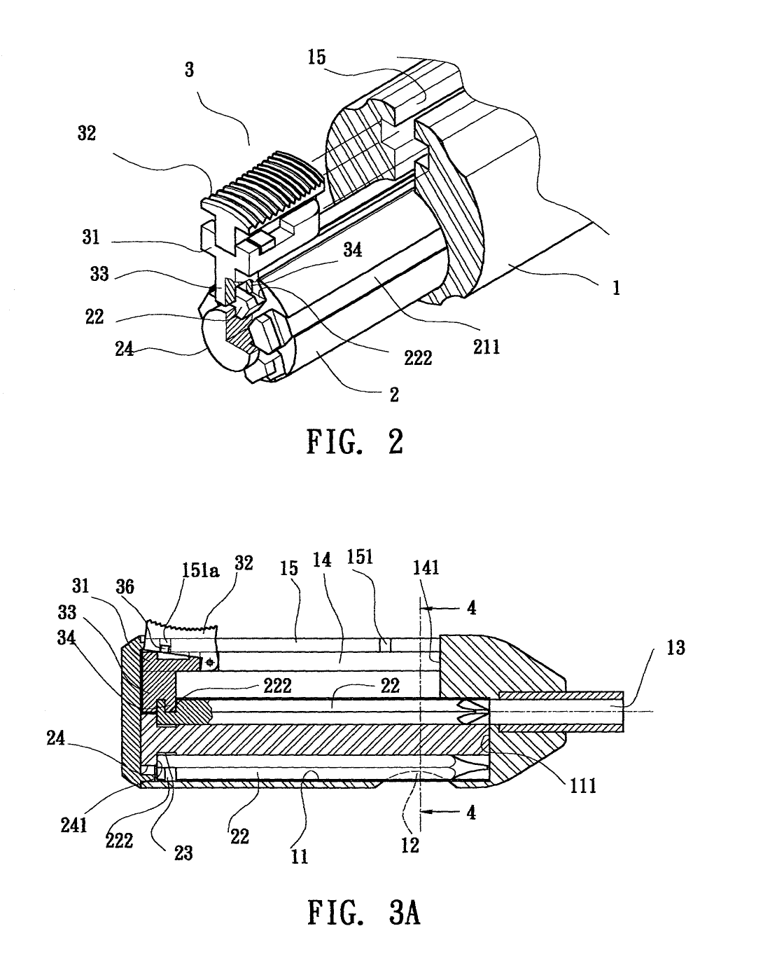

Please refer to FIGS. 1 to 7. The rotary screwdriver with hidden and replaceable screwdriver bits of the present invention includes:

a grip 1 formed with an axially extending receptacle 11, the receptacle 11 being formed in an eccentric position and open on rear end of the grip 1, a roller 2 being disposed in the receptacle, the circumferential wall of the grip 1 being formed with an opening 12 communicating with the receptacle, whereby a user can directly through the opening 12 drives the roller 2 to rotate within the receptacle 11, the roller 2 being formed with multiple receiving tunnels 21 which are annularly arranged at equal intervals, the receiving tunnels 21 axially passing through the roller 2, each receiving tunnel having a slit 211 which is open on rear end of the roller 2, a screwdriver bit 22 being received in each receiving tunnel, a rear end of the screwdriver bit extending out of the roller 2 and having an insertion section 221, the insertion section being formed with a notch 222 radially passing through the screwdriver bit;

a cover 18 disposed at rear end of the grip 1 for preventing the roller 2 and the screwdriver bits 22 from dropping out from rear end of the grip 1, the rear end of the roller 2 having a stop face 241 facing the screwdriver bit and positioned between the rear end of the roller 2 and the cover 18, in this embodiment, the stop face being formed in such a manner that the rear end of the roller 2 is formed with a flange 24 and the flange 24 and the rear end of the roller define an annular groove 23, a face of the flange 24 facing the screwdriver bit 22 serving as the stop face 241, when the rear ends of the screwdriver bits 22 abut against the stop face, the insertion sections 221 of the screwdriver bits 22 being positioned on the same cross-section, the screwdriver bits 22 being annularly arranged so that the notches 222 thereof are positioned on the same circumference to prevent the screwdriver bits 22 from rearward dropping, the inner face of front end of the receptacle 11 being formed with a stop face 111 having a forward extending outlet 13, the axis of the outlet passing through the center of the grip 1 in parallel to the axis of the receptacle 11, one side of the receptacle being formed with a slide slot 14 which radially passes through the grip 1 and is open on rear end of the grip 1, when one of the receiving tunnel 11 of the roller 2 is radially aimed at the slide slot 14, the receiving tunnel 11 being axially aimed at the outlet 13, the inner face of front side of the slide slot 14 being also formed with a stop face 141, two slide rails 15 being respectively formed on two lateral sides of the slide slot 14, the front and rear sections of the slide rails 15 are respectively formed with opposite recesses 151; and

a push member 3. In this embodiment, the push member 3 is slidably inlaid in the slide slot 14. The push member 3 is composed of a seat body 31 and a push button 32 overlaid on the seat body 31. The seat body 31 has an engaging section 33 corresponding to the insertion section 221. The engaging section 33 has a downward projecting engaging block 34 corresponding to the notch 222. A spring 35 is disposed between the seat body 31 and the push button 32. Two sides of the push button are respectively formed with two projecting blocks 36 corresponding to the recesses 151. In normal state, the push button 32 is upward pushed by the spring 35 to make the two projecting blocks respectively engaged in the recesses 151 of the slide rails 15. Under such circumstance, the screwdriver bit 22 cannot be back and forth moved and the roller 2 cannot be rotated. By means of pressing the push button 32, the projecting blocks 36 can be disengaged from the recesses 151 to move to lower sides of the slide rails 15, permitting the push member 3 to slide back and forth. When the projecting blocks are engaged in the recesses 151a of rear sections of the slide rails, the rear end of the screwdriver bit 22 inserted in the push member 3 right abuts against the stop face 241 of the flange 24. At this time, the rear ends and insertion sections 221 of the respective screwdriver bits are positioned on the same cross-section.

The roller 2 is formed with engaging grooves 25 in positions where the respective screwdriver bits are aimed at the outlet 13. The inner face of the wall of the receptacle 11 is provided with a steel bead 16 corresponding to the engaging grooves 25. The steel bead is pushed by a spring 17 to protrude from the inner face of the wall of the receptacle 11. When turning the roller 2 to replace the screwdriver bit 22, the steel bead 16 is engaged and located in one of the engaging grooves 25 to ensure that the screwdriver bit 22 is aimed at the outlet 13.

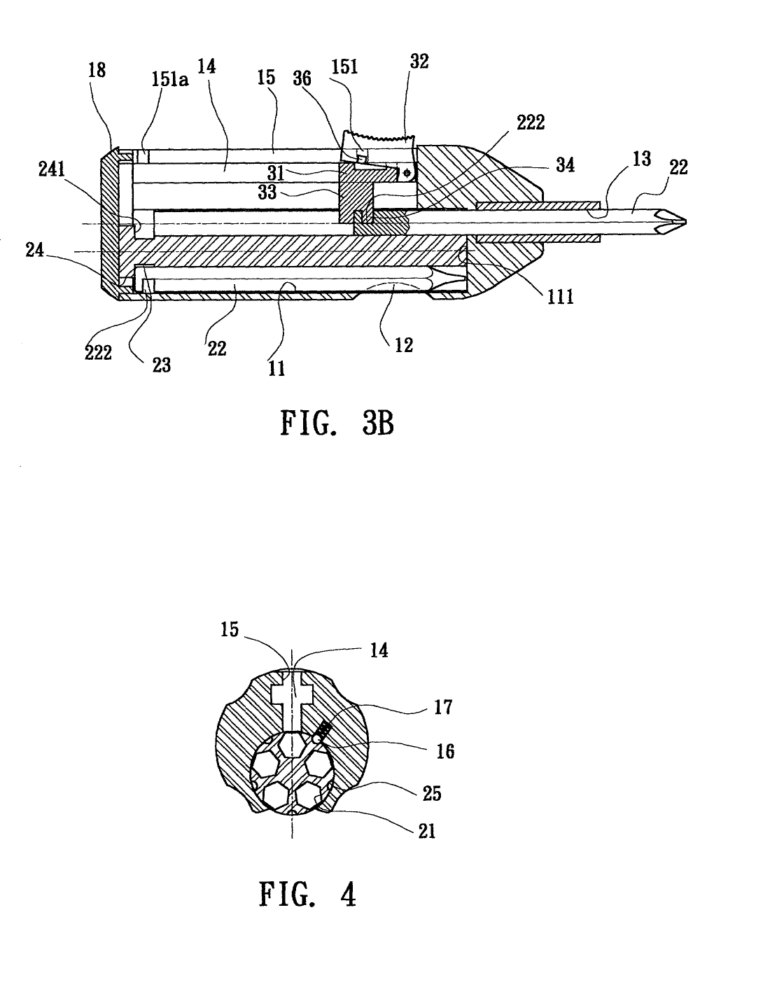

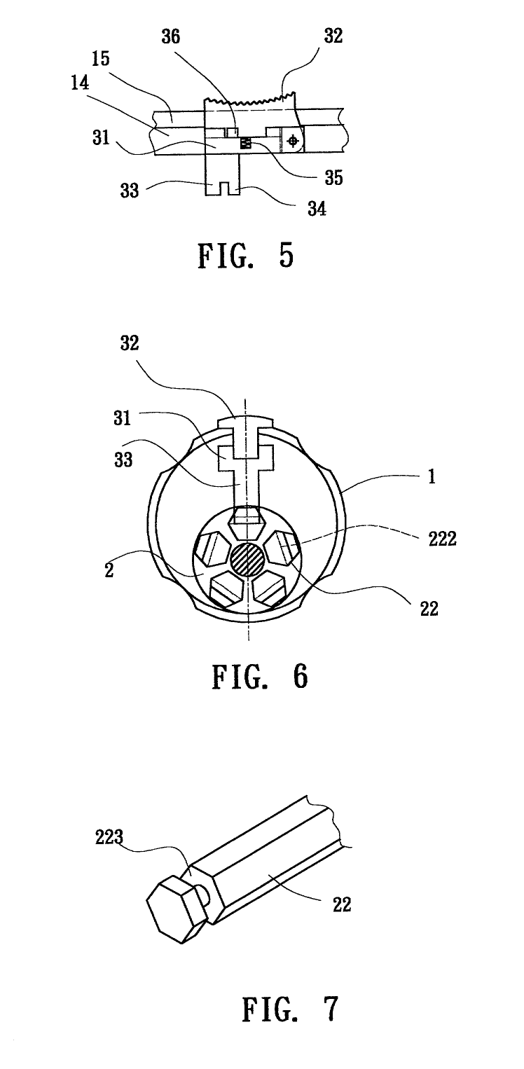

Referring to FIGS. 3 and 5, in use, the push button 32 is first depressed to make the projecting blocks 36 disengaged from the recesses 151a and downward moved to lower sides of the slide rails 15. Then the push member 3 is forward pushed to make the screwdriver bit move forward and extend out of the outlet 13. When the push member reaches the recesses 151 of front sections of the slide rails 15, the push button 32 is released to engage the projecting blocks 36 respectively in the recesses 151. At this time, the push member 3 cannot be moved back and forth and the roller 2 cannot be rotated, so that the screwdriver bit 22 is firmly located for use.

Similarly, when storing the screwdriver bit 22, the push button 32 is depressed and the push member 3 is moved rearward to make the rear end of the screwdriver bit 22 inserted in the push member 3 abut against the stop face 241. At this time, the push button 32 is released to engage the projecting blocks 36 in the recesses 151a.

When replacing screwdriver bit 22 with a different one, since the insertion sections 221 of the screwdriver bits 22 are positioned on the same cross-section and the notches 222 of the insertion sections 221 radially pass through the screwdriver bits and are positioned on the same circumference, a user can through the opening 12 drive and rotate the roller 2 By means of the engagement between the steel bead 16 and the engaging groove 25, the user can ensure that the screwdriver bit 22 to be used is aimed at the outlet 13. Then the push member 3 is pushed forward to drive the screwdriver bit 22 to extend out of the outlet for use.

FIG. 7 shows another type of insertion section of the screwdriver bit. The insertion section is formed with an annular groove 223, whereby the insertion section can be transversely moved relative to the push member, permitting the roller to rotate.

In addition, the inner face of the cover 18 can be formed with an inward protruding disc. A face of the protruding disc facing the screwdriver bit serves as the stop face 241 to achieve the above stopping effect.

In conclusion, the grip is formed with a slide slot raidally communicating with the receptacle. A push member is disposed in the slide slot and can be engaged with one of the screwdriver bits received in the roller. When replacing the screwdriver bit with a different one, a user only needs to directly push the push member to push back the original screwdriver bit and then turn the roller to aim a desired screwdriver bit at the outlet. Then, via the push member, the screwdriver bit is pushed out for use.

In addition, when replacing the screwdriver bit, the screwdriver bit originally inserted in the coupling stem and the desired screwdriver bit are both unnecessary to be extracted and can be directly switched. Therefore, the screwdriver bits are not easy to miss.

When pushing the push member forward to extend the screwdriver bit out of the outlet for use, the insertion section of the screwdriver bit is engaged with the push member and the projecting blocks of the push member are right engaged in the recesses of the slide rails and stopped by the stop face. Therefore, the push member can be firmly fixed in the slide slot without moving. Accordingly, the screwdriver bit is firmly located without loosening due to greater force during working.

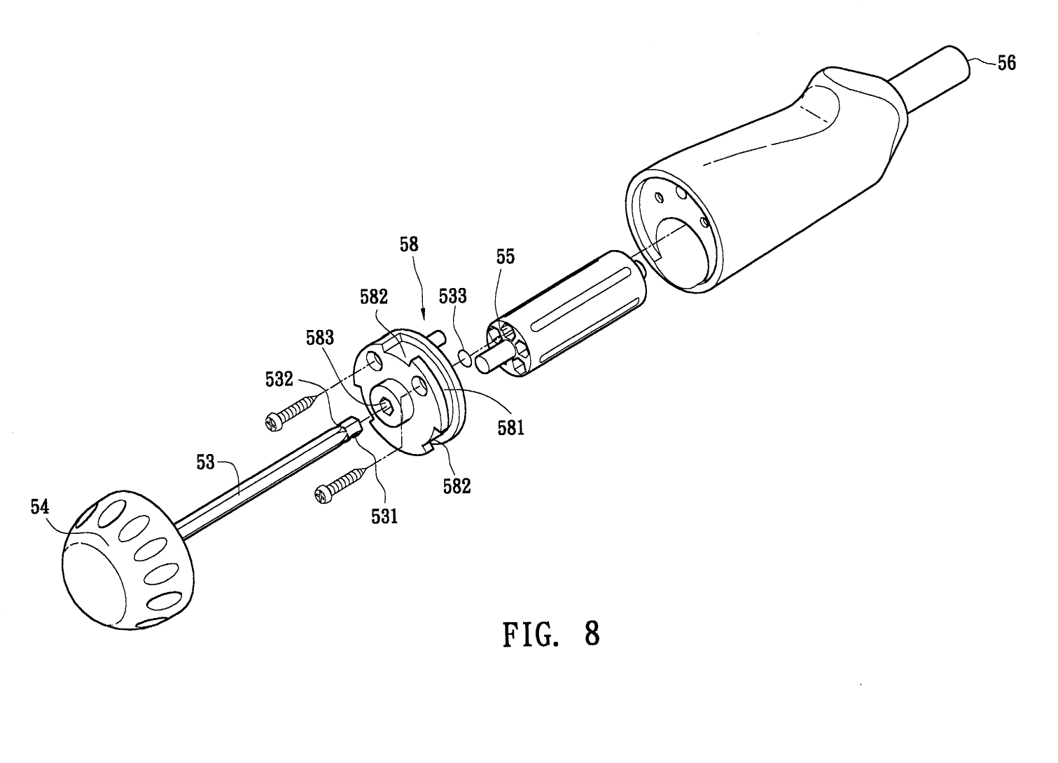

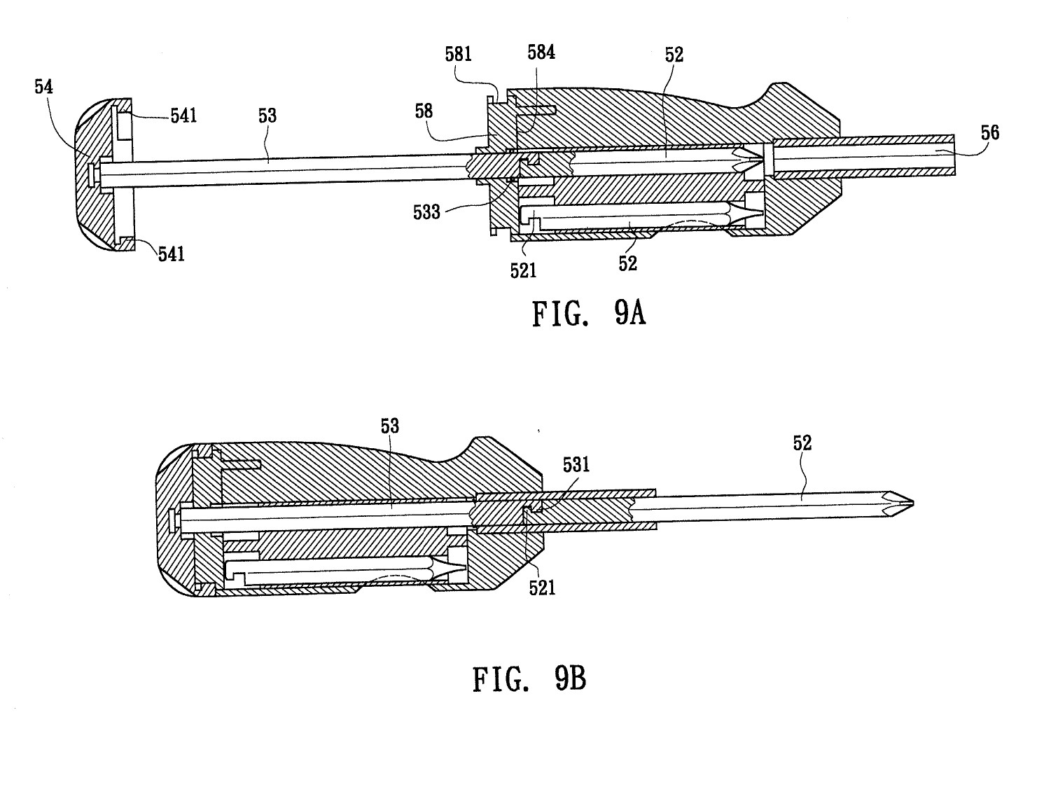

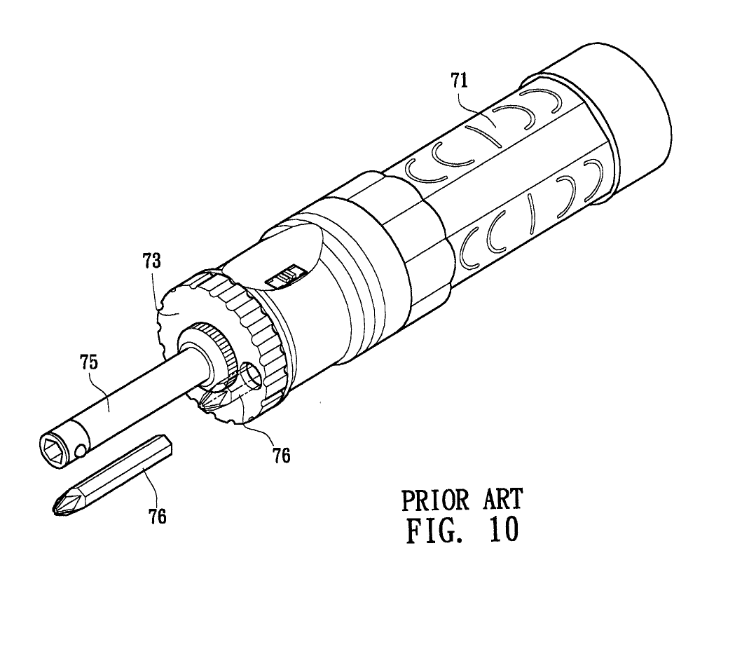

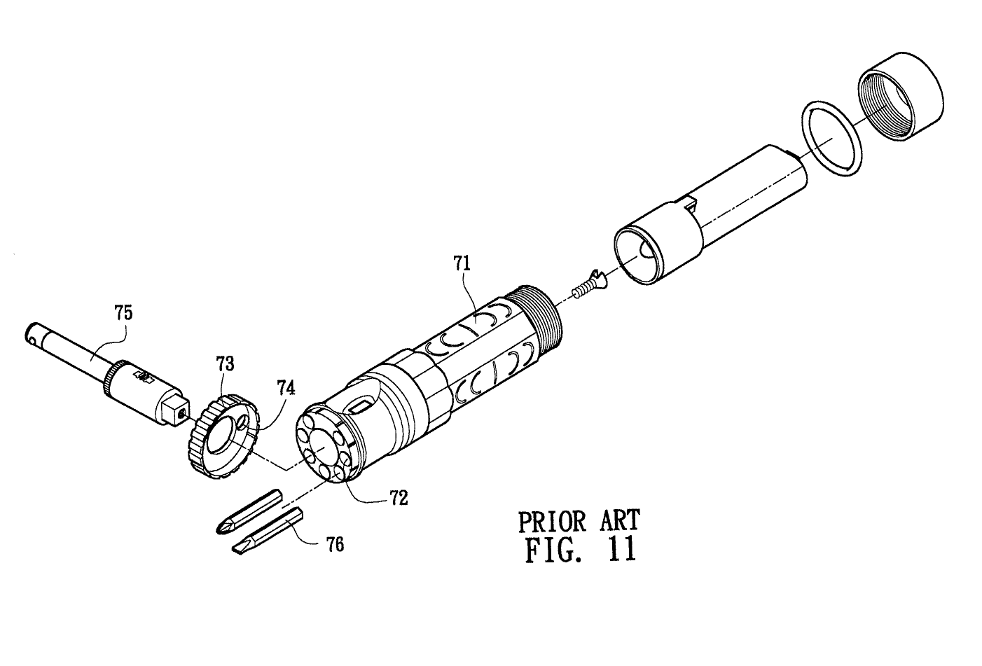

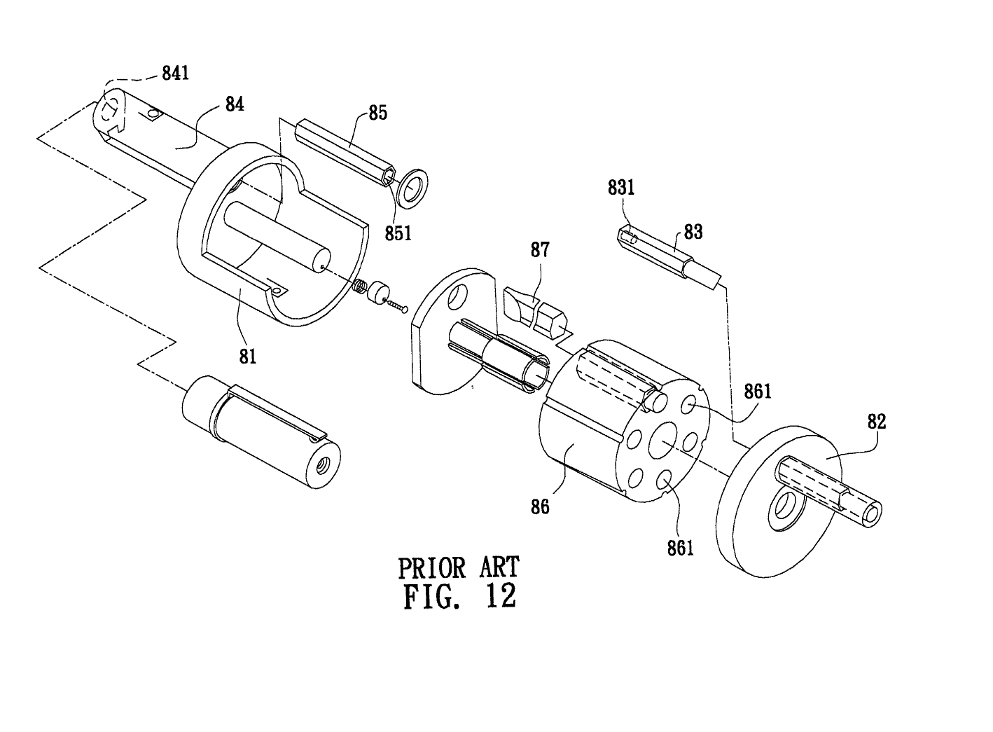

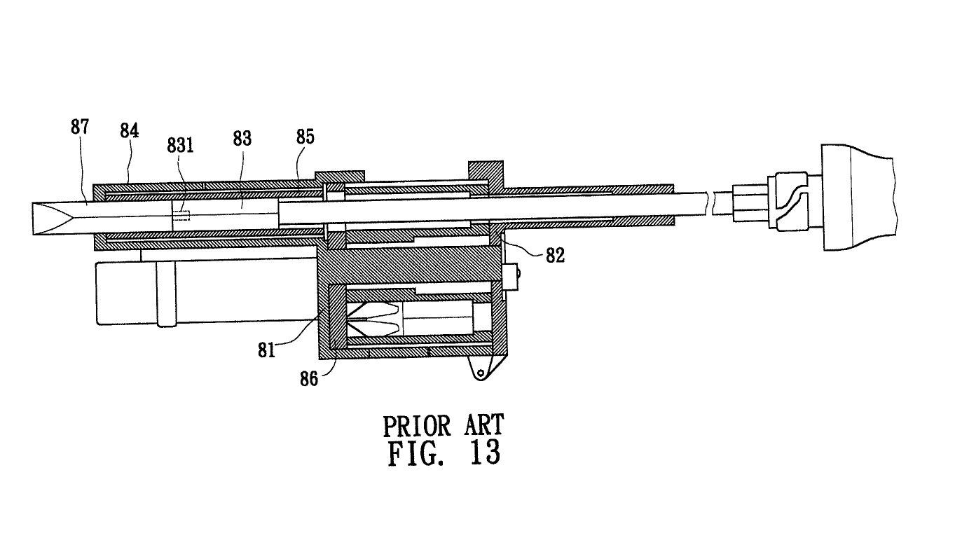

FIGS. 8 and 9 show a second embodiment of the present invention, in which the cover 58 has a certain thickness and rearward protrudes from the grip 5. The outer circumference of the cover is formed with an annular groove 581. A rear side wall of the annular groove 581 is formed with multiple notches 582 which are annular arranged. The cover is formed with an axial through hole 583 concentric with the outlet 56. The inner face of the cover serves as a stop face 584 for stopping the rear end of the screwdriver bit 52 and making the insertion sections of the respectively screwdriver bits 52 positioned on the same cross-section, permitting the roller to rotate.

The push member is a push rod 53 extending through the through hole 583 of the cover 58. The front end of the push rod is formed with an engaging section 531 corresponding to the insertion section 521 of the screwdriver bit for engaging therewith. An annular stop section 532 is formed on the push member near front end thereof. A retainer ring 533 is fitted on rear side of the stop section. When rearward pulling the push rod, the retainer ring abuts against the inner side of the cover and the front side of the retainer ring is stopped by the stop section so that the push rod is prevented from being pulled out of the grip.

An outer cap 54 is rotatably disposed on rear end of the push rod. The inner circumference of the outer cap is formed with projecting blocks 541 which are annularly arranged corresponding to the notches of the cover. In normal state, the outer cap is fitted on outer side of the cover 58 with the projecting blocks engaged in the annular groove 581. Under such circumstance, the outer cap cannot be rearward pulled.

When replacing the screwdriver bit, a user can first rotate the outer cap 54 to respectively aim the projecting blocks 541 at the notches 582 of the cover. Then the outer cap is pulled rearward until the retainer ring 533 is stopped by the inner side of the cover. At this time, the rear end of the screwdriver bit engaged with the push rod 53 and the rear ends of the other screwdriver bits are positioned on the same cross-section. Then the roller is rotated to aim the desired screwdriver bit at the outlet and the outer cap 54 is pushed forward to extend the push rod 53 into the receiving tunnel 55 and push the desired screwdriver bit out of the outlet for use.

Finally, the outer cap 54 is rotated to move the projecting blocks 541 from the notches 582 of the cover. Under such circumstance, the outer cap and the push rod cannot be retreated.

Similarly, when replacing the screwdriver bit, the screwdriver bit originally inserted in the coupling stem and the desired screwdriver bit are both unnecessary to be extracted and can be directly switched. Therefore, the screwdriver bits are not easy to miss.

When forward pushing the push rod to extend the screwdriver bit out of the outlet for use, the insertion section of the screwdriver bit is engaged with the push rod and the projecting blocks of the outer cap are engaged in the annular groove of the cap. Therefore, the push rod can be firmly fixed in the slide slot without moving. Accordingly, the screwdriver bit is firmly located without loosening as in the first embodiment.

The above embodiments are only used to illustrate the present invention, not intended to limit the scope thereof. Many modifications of the above embodiments can be made without departing from the spirit of the present invention.

What is claimed is:

1. A rotary screwdriver with hidden and replaceable screwdriver bits, comprising a grip and a push member, the push member having an engaging section, the grip being formed with an axially extending receptacle which is formed in an eccentric position and open on rear end of the grip, the axis of the outlet passing through the center of the grip in parallel to the axis of the receptacle, a roller being disposed in the receptacle, the roller being formed with multiple receiving tunnels which are annularly arranged at intervals, a screwdriver bit being received in each receiving tunnel, by means of rotating the roller, the screwdriver bit being aimed at the outlet, each screwdriver bit being formed with an insertion section corresponding to the engaging section for engaging with the push member, a cover being disposed on rear end of the grip for preventing the roller and screwdriver bits from rearward dropping out of the grip, whereby by means of rotating the roller, the push member can be engaged with a desired screwdriver bit of the multiple screwdriver bits, by means of pushing the push member, the screwdriver bit engaged with the push member is pushed out of the outlet and located for use or retracted into the receiving tunnel.

2. The rotary screwdriver with hidden and replaceable screwdriver bits as claimed in claim 1, wherein the receptacle is formed with a slide slot which radially passes through the grip and is open on rear end of the grip, each receiving tunnel having a slit corresponding to the slide slot, the slit being open on rear end of the roller, the push member being slidably disposed in the slide slot, whereby by means of rotating the roller, the push member can be engaged with a desired screwdriver bit of the multiple screwdriver bits and by means of pushing the push member to move along the slide slot and the slit, the screwdriver bit engaged with the push member is pushed out of the outlet and located for use.

3. The rotary screwdriver with hidden and replaceable screwdriver bits as claimed in claim 2, wherein two slide rails are respectively formed on two lateral sides of the slide slot, a front and a rear sections of the slide rails being respectively formed with opposite recesses, the push member being composed of a seat body and a push button overlaid thereon, a spring being disposed between the seat body and the push button, two sides of the push button being respectively formed with two projecting blocks corresponding to the recesses, whereby in normal state, the push button is upward pushed by the spring to make the two projecting blocks respectively engaged in the recesses of the slide rails and the screwdriver bit cannot be back and forth moved and the roller cannot be rotated, by means of pressing the push button, the projecting blocks being disengageable from the recesses, permitting the push member to slide back and forth.

4. The rotary screwdriver with hidden and replaceable screwdriver bits as claimed in claim 1, wherein the engaging section has a projecting engaging block and the insertion section is formed with a notch transversely passing through the screwdriver bit corresponding to the engaging block for engaging therewith, by means of the notches, the insertion sections of the screwdriver bits being transversely movable relative to the push member, permitting the roller to rotate.

5. The rotary screwdriver with hidden and replaceable screwdriver bits as claimed in claim 1, wherein the rear end of the roller has a stop face facing the screwdriver bit and positioned between the rear end of the roller and the cover, whereby when the rear ends of the respective screwdriver bits are stopped by the stop face, the rear ends and the insertion sections of the screwdriver bits are positioned on the same cross-section, permitting the roller to rotate.

6. The rotary screwdriver with hidden and replaceable screwdriver bits as claimed in claim 5, wherein the rear end of the roller is formed with a flange and the flange and the rear end of the roller define an annular groove, a face of the flange facing the screwdriver bit serving as the stop face.

7. The rotary screwdriver with hidden and replaceable screwdriver bits as claimed in claim 5, wherein the inner face of the cover is formed with an inward protruding disc, a face of the protruding disc facing the screwdriver bit serving as the stop face.

8. The rotary screwdriver with hidden and replaceable screwdriver bits as claimed in claim 1, wherein the roller is formed with engaging grooves in positions where the respective screwdriver bits are aimed at the outlet, the inner face of the wall of the receptacle being provided with a steel bead corresponding to the engaging grooves, the steel bead being pushed by a spring to protrude from the inner face of the wall of the receptacle, whereby when turning the roller, the steel bead is engaged and located in one of the engaging grooves to ensure that the screwdriver bit is aimed at the outlet.

9. The rotary screwdriver with hidden and replaceable screwdriver bits as claimed in claim 1, wherein the cover is formed with an axial through hole concentric with the outlet, the push member being is push rod extending through the through hole, the engaging section being formed on front end of the push rod for engaging with the screwdriver bit, whereby by means of rotating the roller, the push rod can be engaged with a desired screwdriver bit of the multiple screwdriver bits, by means of pushing the push rod, the screwdriver bit engaged with the push rod being pushed out of the outlet and located for use or retracted into the receiving tunnel.

10. The rotary screwdriver with hidden and replaceable screwdriver bits as claimed in claim 9, wherein cover has a certain thickness and rearward protrudes from the grip, an outer circumference of the cover being formed with an annular groove, a rear side wall of the annular groove being formed with multiple notches which are annular arranged, an outer cap being rotatably disposed on rear end of the push rod, an inner circumference of the outer cap being formed with projecting blocks which are annularly arranged corresponding to the notches of the cover, whereby by means of rotating the outer cap to respectively aim the projecting blocks at the notches of the cover, the outer cap and the push rod can be pulled rearward or by means of rotating the outer cap, the projecting blocks can be engaged in the annular groove to prevent the outer cap from being rearward pulled.
